(19) United States
(12) Patent Application Publication
(10) Pub. No.: US 2007/0187500 A1
(43) Pub. Date: Aug. 16, 2007

(54) CARD PRINTER HAVING A CAM TO PUSH A MAGNETIC HEAD BEARER AWAY FROM AN ENCODER ROLLER

(76) Inventor: Sheng-Jien Lin, Tai-Tung Hsien (TW)

Correspondence Address: NORTH AMERICA INTELLECTUAL PROPERTY CORPORATION, P.O. BOX 506, MERRIFIELD, VA, 22116, US

(21) Appl. No.: 11/457,149

(22) Filed: Jul. 13, 2006

(30) Foreign Application Priority Data
Feb. 10, 2006 (TW) 095104590

(51) Int. Cl. G06K 7/08; G06F 15/12

(52) U.S. Cl. 235/449; 235/432

(57) ABSTRACT

A card printer has a card conveyor for conveying along a card conveying route a card having a magnetic strip for storing data , a magnetic head bearer installed on a first side of the card conveying route, a magnetic head installed on the magnetic head bearer for accessing data of the magnetic strip, an encoder roller installed on a second side of the card conveying route for calculating a length of the card passing by the magnetic head, a cam for pushing the magnetic head away from the encoder roller after the magnetic head reads the data stored in the magnetic strip, and a thermal print head installed by one side of the card conveying route for printing a pattern onto the card after the cam pushes the magnetic head bearer to move away from the encoder roller.

### BACKGROUND OF THE INVENTION

1. Field of the Invention

The present invention relates to a card printer, and more specifically, to a card printer having a cam to push a magnetic head bearer away from an encoder roller.

2. Description of the Prior Art

A card printer is an electronic device that can write data onto a magnetic strip of a card, read data from the magnetic strip, and print a predetermined pattern onto the card. Card printers have been widely applied to process items such as individual IDs (e.g. employee ID tags) and individual medical histories.

The operation of the card printer is as follows. When a card enters a card printer, a magnetic head of the card printer writes data onto a magnetic strip of the card, and then reads data from the magnetic strip. After a processor in the card printer verifies the consistency of the data read by the magnetic head and the data previously written onto the magnetic strip, a thermal print head in the card printer prints the predetermined pattern onto the card.

During the operation of the card printer according to the prior art, the magnetic head must be kept in contact with the magnetic strip in order to correctly write data onto or read data from the magnetic strip. Therefore, the card printer in the prior includes a fixed elastic piece set to ensure that the magnetic head keeps contacting with the card, i.e., the magnetic head keeps contacting with the magnetic strip in the card, when the card passes by the magnetic head. Unfortunately, the magnetic head has short life because of its constant contact with the card, and besides, interference due to the contact between the magnetic head and the card can have a destructive effect on clearance when the thermal print head is going to print the predetermined pattern onto the card.

To solve the problem mentioned above, the thermal print head is located far from the magnetic head in the prior art card printer to make sure that when the thermal print head is printing the predetermined pattern onto the card, the card is kept away from the magnetic head and is unlikely to contact the magnetic head. However, this solution demands that the card reader be physically larger.

### SUMMARY OF THE INVENTION

The claimed invention provides a card printer having a cam to push a magnetic head bearer away from an encoder roller. The card printer comprises a card conveyor for conveying along a card conveying route a card having a magnetic strip for storing data; a magnetic head bearer installed on a first side of the card conveying route; a magnetic head installed on the magnetic head bearer for accessing data of the magnetic strip when the card passes by the magnetic head; an encoder roller installed on a second side of the card conveying route for calculating a length of the card passing by the magnetic head; a cam for pushing the magnetic head bearer away from the encoder roller after the magnetic head reads the data stored in the magnetic strip; and a thermal print head installed on one side of the card conveying route for printing a pattern onto the card after the cam pushes the magnetic head bearer away from the encoder roller.

The claimed invention further provides a card printer having a cam to push a encoder roller bearer away from a magnetic head. The card printer comprises a card conveyor for conveying along a card conveying route a card having a magnetic strip for storing data; a magnetic head installed on a first side of the card conveying route for accessing data of the magnetic strip when the card passes by the magnetic head; an encoder roller bearer installed on a second side of the card conveying route; an encoder roller installed on the encoder roller bearer for calculating a length of the card passing by the magnetic head; a cam for pushing the encoder roller bearer away from the magnetic head after the magnetic head reads the data stored in the magnetic strip; and a thermal print head installed on one side of the card conveying route for printing a pattern onto the card after the cam pushes the encoder roller bearer away from the encoder roller.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are illustrations of a preferred exemplary embodiment of a card printer according to the present invention.

FIG. 3 is an illustration of part of the card printer in FIG. 1.

FIG. 4 is an illustration of a top view of the card printer in FIG. 1.

FIG. 5 and FIG. 6 are illustrations of a magnetic head, a magnetic head bearer, and a cam.

FIG. 7 and FIG. 8 are illustrations of the cam in FIG. 5.

FIG. 9 and FIG. 10 are exploded illustrations of the magnetic head, the magnetic head bearer, and the cam in FIG. 5.

FIG. 11 and FIG. 12 are illustrations of an encoder roller, an encoder roller bearer of the card printer in FIG. 1, and the cam in FIG. 5.

FIG. 13 and FIG. 14 are exploded illustrations of the encoder roller and the encoder roller bearer in FIG. 11.

FIG. 15 and FIG. 16 are illustrations of an idler, an idler bearer, a gear set, and an idle cam of the card printer in FIG. 1.

FIG. 17 and FIG. 18 are exploded illustrations of the idler, the idler bearer, the gear set, and the idle cam in FIG. 15.

FIG. 19 is a functional block diagram of the card printer in FIG. 1.

### DETAILED DESCRIPTION

A card printer according to the present invention rotates a cam in accordance with the working status of a magnetic head. The card printer can further control the positions of a magnetic head bearer, an encoder roller bearer, and an idler bearer to be in a close-up position or in an open position. When the magnetic head of the card printer is writing data onto a magnetic strip of a card or reading data from the magnetic strip, the cam rotates to a cam close-up position to direct the magnetic head bearer, the encoder roller bearer, and the idler bearer to each close-up position in order to press the card against the magnetic head. Thus, the magnetic head can keep in contact with the magnetic strip, thereby writing data onto the magnetic strip or reading data from the strip. On the other hand, as a thermal print head of the card printer is printing a predetermined pattern onto the card, while the magnetic head is not operating, the cam rotates to a cam open position, which also directs the magnetic head bearer, the encoder roller bearer, and the idler bearer to each open position. In such situation, the magnetic head, the encoder roller on the encoder roller bearer, and the idler on the idler bearer do not contact the card. This allows the thermal print head to print the predetermined pattern onto the card without interference.

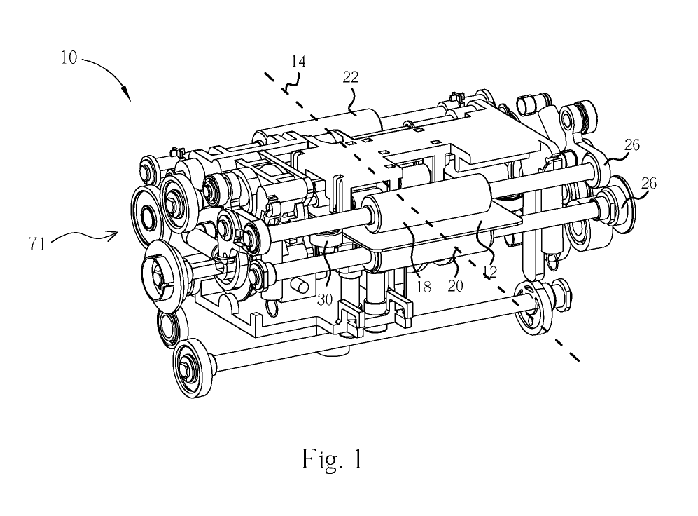

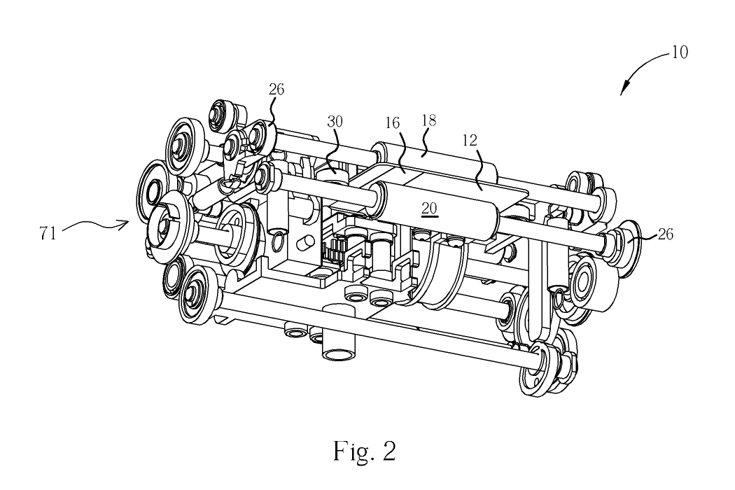

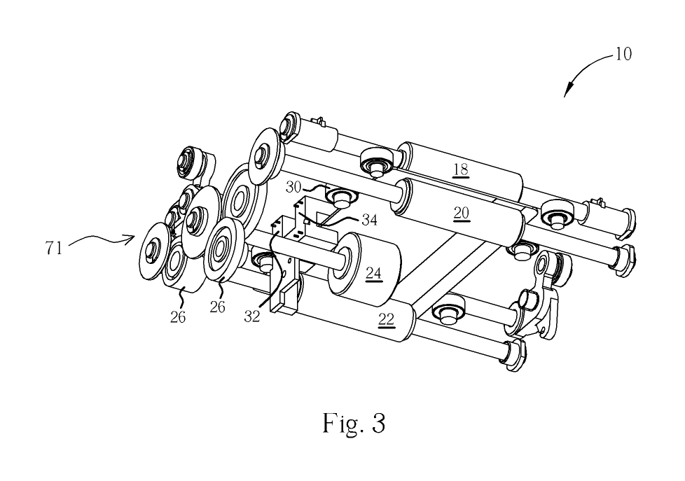

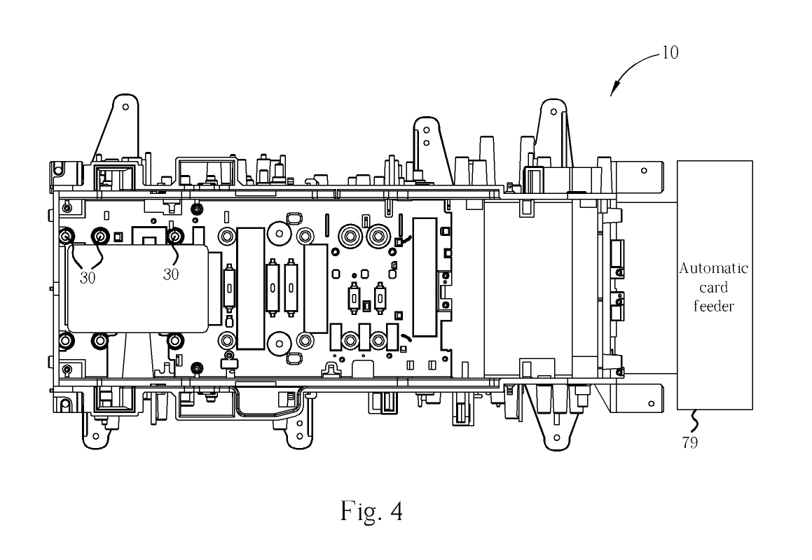

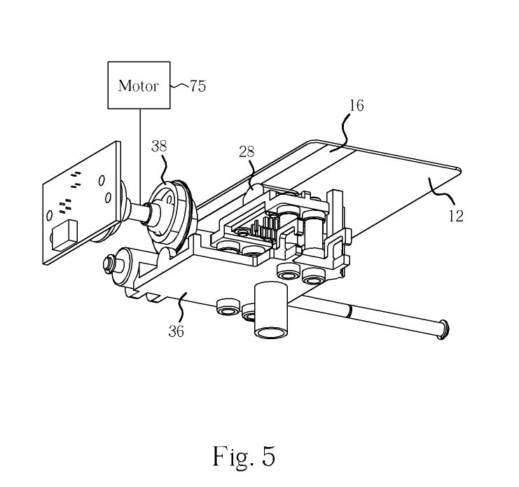

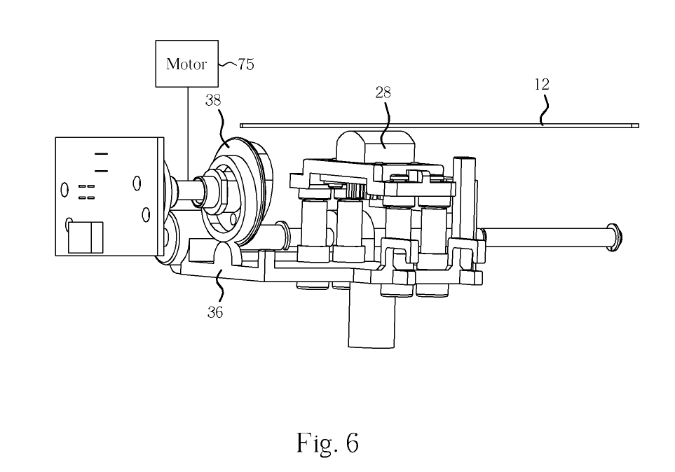

Please refer to FIG. 1 to FIG. 4. FIG. 1 and FIG. 2 are illustrations of a preferred exemplary embodiment of a card printer 10 according to the present invention. FIG. 3 is an illustration of part of the card printer 10. FIG. 4 is an illustration of a top view of the card printer 10. The card printer 10 comprises a card conveyor 71 for conveying along a card conveying route 14 a card 12 back and forth. The card 12 has a magnetic strip 16 for storing data. In the preferred exemplary embodiment of the present invention, the card conveyor 71 comprises a plurality of rollers 18, 20, and 22, an auxiliary roller 24, and a plurality of gears 26 for corporately conveying the card 12 along the card conveying route 14. The auxiliary roller 24 stabilizes the conveying when the card passes a magnetic head 28 of the card printer 10 (The magnetic head 28 is shown in FIG. 5 and in FIG. 6.).

The card printer 10 further comprises a plurality of bearing rollers 30 installed at both sides of the card conveying route 14 for confining the card 12 to be conveyed along the card conveying route 14. With the plurality of bearing rollers 30, the card 12 goes straight along the card conveying route 14 and is unlikely to deviate.

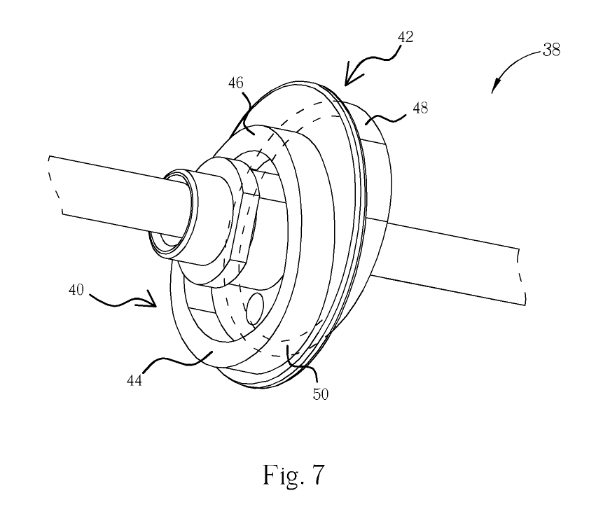

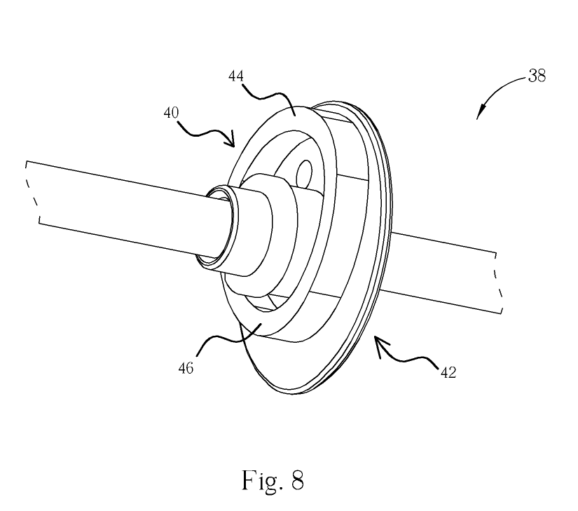

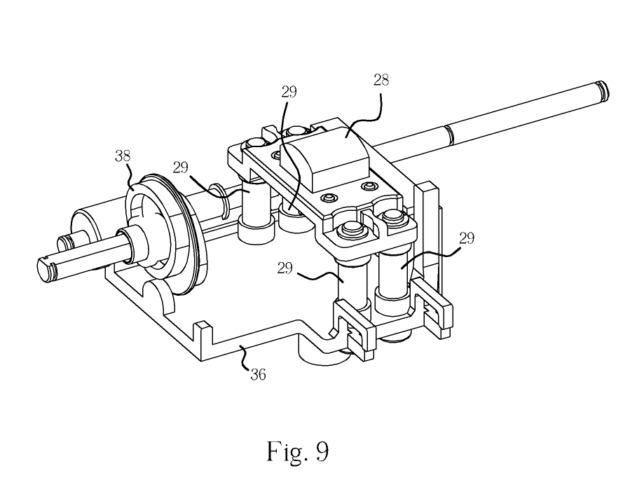

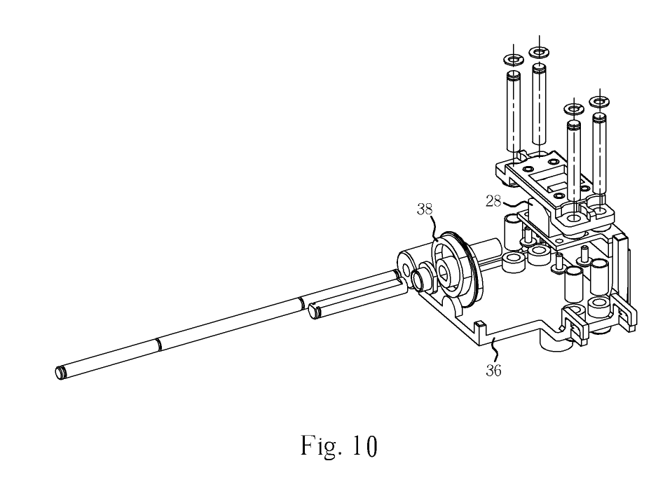

Please refer to FIG. 5 to FIG. 10. FIG. 5 and FIG. 6 are illustrations of the magnetic head 28, a magnetic head bearer 36 for holding the magnetic head 28, and a cam 38 of the card printer 10. FIG. 7 and FIG. 8 are illustrations of the cam 38. FIG. 9 and FIG. 10 are exploded illustrations of the magnetic head 28, the magnetic head bearer 36, and the cam 38. The cam 38 comprises a magnetic head surface 40 and an encoder roller surface 42. The magnetic head surface 40 comprises a long shaft 44 and a short shaft 46. The encoder roller surface 42 comprises a long shaft 48 and a short shaft 50. The magnetic head 28 in FIG. 9 uses a plurality of springs 29 as supports to replace the elastic pieces in the prior art so that the magnetic head 28 can keep in contact with the magnetic strip 16.

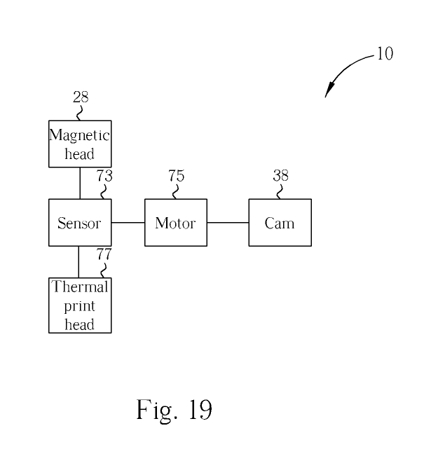

Please refer to FIG. 19, which is a functional block diagram of the card printer 10. The card printer 10 further comprises a sensor 73, a motor 75, and a thermal print head 77. When the sensor 73 of the card printer 10 detects that the magnetic head 28 is writing data onto or reading data from the magnetic strip 16 of the card 12, the sensor 73 drives the motor 75 to rotate the cam 38 to the cam close-up position, as FIG. 8 shows. The cam 38 rotating to the cam close-up position presses against the magnetic head bearer 36 with the short shaft 46 of its magnetic head surface 40 so that the magnetic head bearer 36 is restrained in a magnetic head bearer close-up position, and the magnetic head 28 can keep contacting the magnetic strip 16 for writing data onto or reading data from the magnetic strip 16, which is shown in FIG. 5. On the other hand, when the sensor 73 detects that the magnetic head 28 is neither writing data onto nor reading data from the magnetic strip 16 of the card 12, it drives the motor 75 to rotate the cam 38 to a cam open position. As FIG. 7 shows, the cam 38 rotating to the cam open position presses against the magnetic head bearer 36 with the long shaft 44 of its magnetic head surface 40 so that the magnetic head bearer 36 is restrained in the opening position, and the magnetic head 28 is not contacting the magnetic strip 16, in other words, the magnetic head 28 is not contacting the card 12, as FIG. 6 shows.

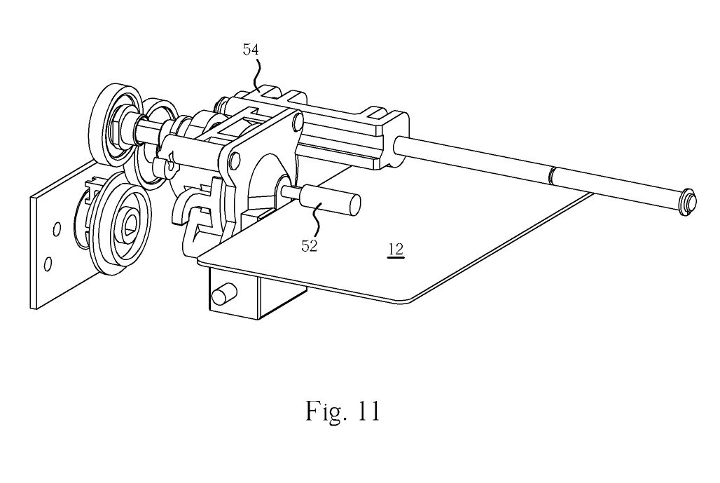

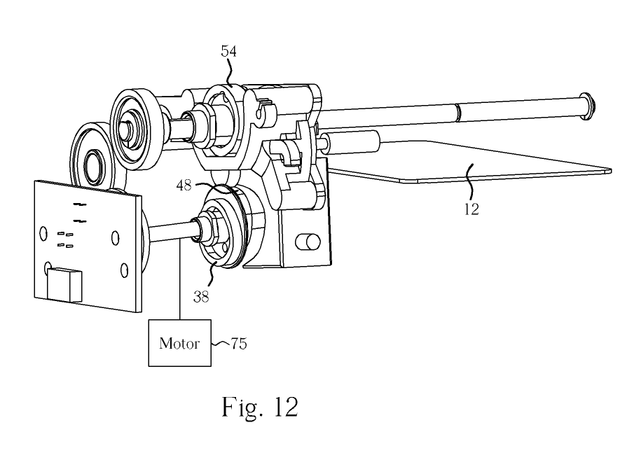

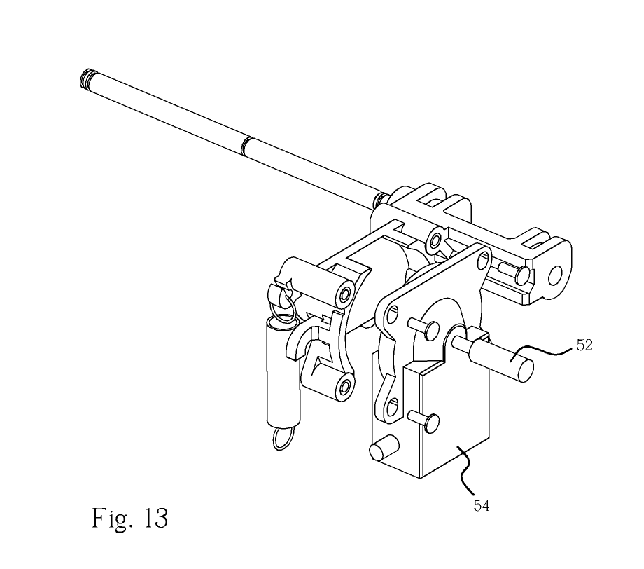

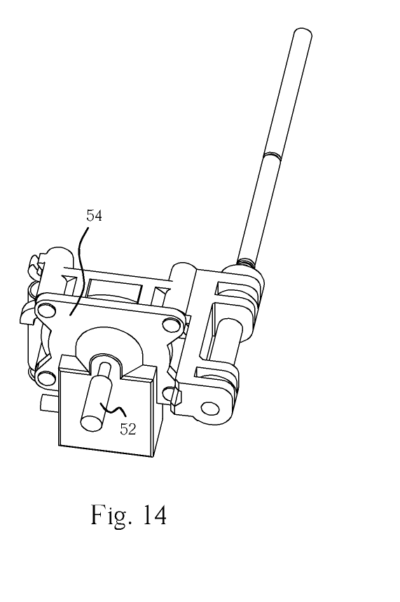

Please refer to FIG. 7, FIG. 8, and FIG. 11 to FIG. 14. FIG. 11 and FIG. 12 are illustrations of an encoder roller 52, an encoder roller bearer 54 for holding the encoder roller 52, and the cam 38. The encoder roller 52 is for calculating a length of the card 12 passing by the magnetic head 28. FIG. 13 and FIG. 14 are exploded illustrations of the encoder roller 52 and the encoder roller bearer 54.

Similarly, when the sensor 73 detects that the magnetic head 28 is operating, the sensor 73 drives the motor 75 to rotate the cam 38 to the cam close-up position. As FIG. 8 shows, the cam 38 rotating to the cam close-up position presses against the encoder roller bearer 54 with the short shaft 50 of its encoder roller surface 42 so that the encoder roller bearer 54 is restrained in the encoder roller bearer close-up position and the encoder roller 52 can keep contacting the card 12, as FIG. 11 shows. On the other hand, when the sensor 73 detects that the magnetic head 28 is neither writing data onto nor reading data from the magnetic strip 16 of the card 12, the sensor 73 drives the motor 75 to rotate the cam 38 to the cam open position. As FIG. 7 shows, the cam 38 rotating to the opening position presses against the encoder roller bearer 54 with the long shaft 48 of its encoder roller surface 42 so that the encoder roller bearer 54 is restrained in the opening position and the encoder roller 52 is not contacting the card 12, as FIG. 12 shows.

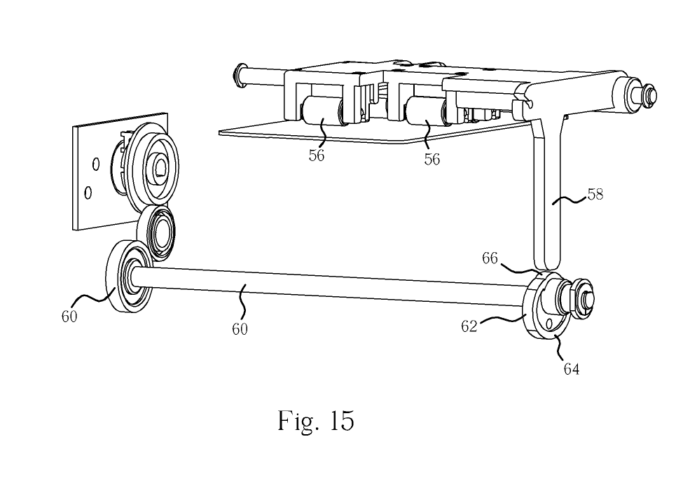

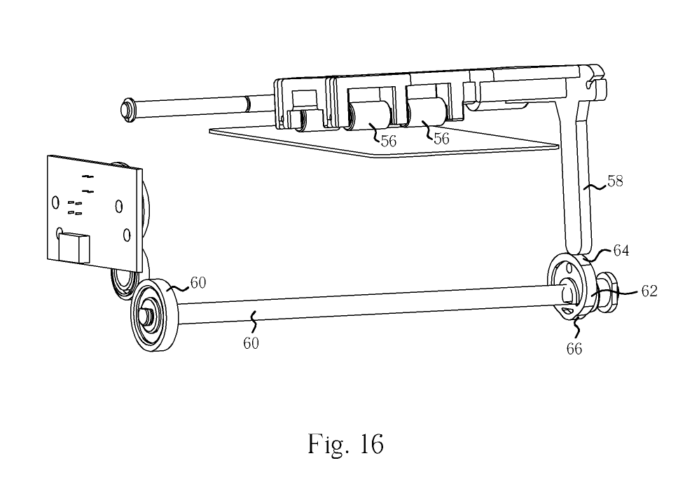

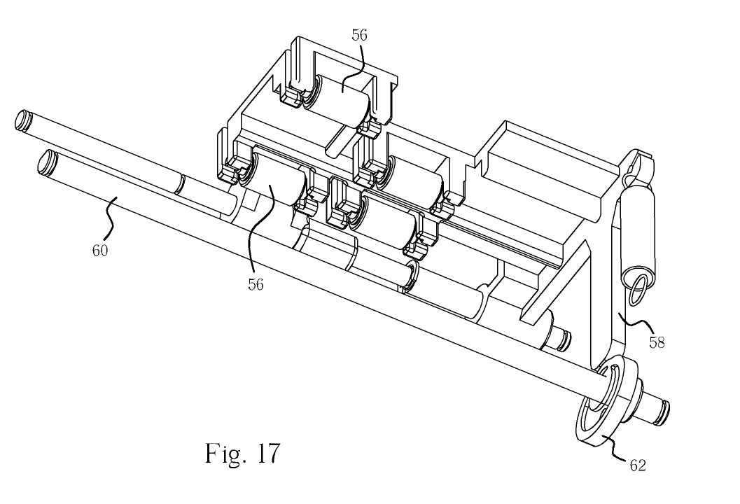

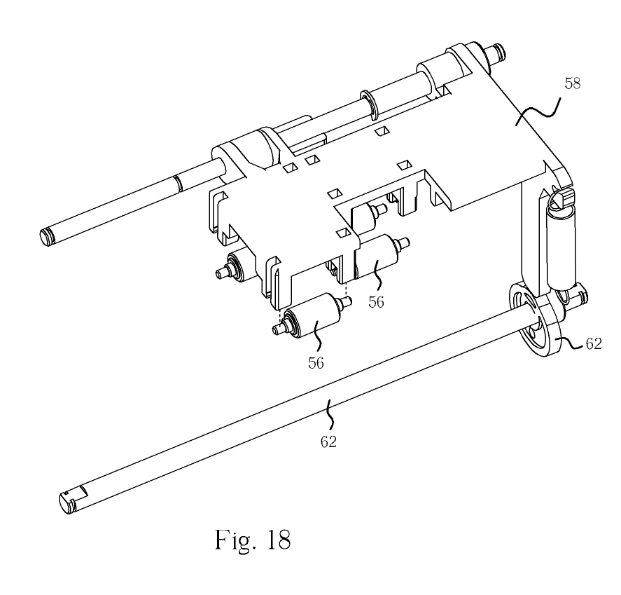

Please refer to FIG. 15 to FIG. 18. FIG. 15 and FIG. 16 are illustrations of idlers 56, an idler bearer 58 for holding the idlers 56, a gear set 60, and an idle cam 62. The idlers 56 are for pressing against the card 12 when the card 12 conveyed to the card conveying route 14. One end of the gear set 60 is connected to the cam 38 and another end is connected to an idle cam 62. The idle cam 62 comprises a long shaft 62 and a short shaft 66. FIG. 17 and FIG. 18 are exploded illustrations of the idlers 56, the idler bearer 58, the gear set 60, and the idle cam 62.

Similarly, when the sensor 73 detects that the magnetic head 28 is operating, the sensor 73 drives the motor 75 to rotate the cam 38 to the cam close-up position. As FIG. 8 shows, since the idle cam 62 is connected to the cam 38 through the gear set 60, the idle cam 62 rotates to an idle cam close-up position and presses against the idler bearer 58 with its short shaft 66 so that the idler bearer 58 is restrained in an idler bearer close-up position and the idler 58 can press against the card 12, as FIG. 15 shows. On the other hand, when the sensor 73 detects that the magnetic head 28 is neither writing data onto nor reading data from the magnetic strip 16 of the card 12, the sensor 73 drives the motor 75 to rotate the cam 38 to the cam open position. As FIG. 7 shows, the motor 75 also rotates the idle cam 62 to an idle cam opening position. The idle cam 62 rotating to the idle cam open position presses against the idler bearer 58 with its long shaft 64 so that the idler bearer 58 is restrained in its opening position and the idler 56 is not contacting the card 12, as FIG. 18 shows.

A thermal print head of the card printer 10 is installed on one side of the card conveying route 14 for printing a pattern onto the card 12 when the magnetic head 28 stop operating. As mentioned above, when the magnetic head 28 stops operating, i.e., when the sensor 73 detects that the magnetic head 28 is neither writing data onto nor reading data from the magnetic strip 16 of the card 12, the sensor 73 drives the motor 75 to rotate the cam 38 to the cam open position, where the cam 38 can restrain the magnetic head bearer 36 and the encoder roller bearer 54 to their individual open positions respectively. In the meantime, the sensor 73 further drives the motor 75 to rotate the idle cam 62 connected with the cam 38 to the idle cam opening position. In such situation, the magnetic head 28, the encoder roller 52, and the idler 56 are separate from the card 12 so that the thermal print head 77 can print the pattern onto the card 12 without interference.

Please refer to FIG. 3. The card printer 10 further comprises an enabling sensor 32 and an encoder roller sensor 34, both installed along the card conveying route 14. The enabling sensor 32 is for generating an enabling signal to enable the magnetic head 28 when the card 12 passes by the enabling sensor 32. The encoder roller sensor 34 is located opposite the magnetic head 28 for calculating the length of the card 12 passing by the magnetic head 28.

The card printer 10 further comprises an automatic card feeder 79, which is shown in FIG. 4, for containing the card 12 and feeding the card 12 into the card conveying route 14.

The card printer 10 according to the present invention has the feature that the magnetic head 28, the encoder roller 52, and the idler 56 contact the card 12 when the magnetic head is operating, and are removed from the card 12 when the magnetic head 12 is not operating, i.e., the thermal print head 77 is printing the pattern onto the card 12. With the feature of the card printer 10, the thermal print head 77 can print the pattern onto the card 12 without interference.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A card printer having a cam to push a magnetic head bearer away from an encoder roller comprising:
a card conveyor for conveying along a card conveying route a card having a magnetic strip for storing data;
a magnetic head bearer installed on a first side of the card conveying route;
a magnetic head installed on the magnetic head bearer for accessing data of the magnetic strip when the card passes by the magnetic head;
an encoder roller installed on a second side of the card conveying route for calculating a length of the card passing by the magnetic head;
a cam for pushing the magnetic head bearer away from the encoder roller after the magnetic head reads the data stored in the magnetic strip; and
a thermal print head installed on one side of the card conveying route for printing a pattern onto the card after the cam pushes the magnetic head bearer away from the encoder roller.

2. The card printer of claim 1 further comprising:
an idler bearer; and
an idler installed on the idler bearer for pressing against the card when the card is conveyed to the card conveying route.

3. The card printer of claim 2 further comprising:
a gear set with one end connected to the cam; and
an idle cam connected to another end of the gear set for pushing the idler bearer away from the encoder roller after the magnetic head reads the data stored in the magnetic strip.

4. The card printer of claim 1 further comprising an encoder roller bearer on which the encoder roller is installed.

5. The card printer of claim 4 wherein the cam pushes the encoder roller bearer away from the magnetic head when the cam pushes the magnetic head bearer away from the encoder roller.

6. The card printer of claim 1 further comprising a bearing roller installed at both sides of the card conveying route for confining the card to be conveyed along the card conveying route.

7. The card printer of claim 1 further comprising an enabling sensor installed on both sides of the card conveying route for generating an enabling signal to enable the magnetic head when the card passes by the enabling sensor along the card conveying route.

8. The card printer of claim 1 further comprising an automatic card feeder for containing the card and feeding the card into the card conveying route.

9. A card printer having a cam to push an encoder roller bearer away from a magnetic head comprising:
a card conveyor for conveying along a card conveying route a card having a magnetic strip for storing data;
a magnetic head installed on a first side of the card conveying route for accessing data of the magnetic strip when the card passes by the magnetic head;
an encoder roller bearer installed on a second side of the card conveying route;
an encoder roller installed on the encoder roller bearer for calculating a length of the card passing by the magnetic head;
a cam for pushing the encoder roller bearer away from the magnetic head after the magnetic head reads the data stored in the magnetic strip; and
a thermal print head installed on one side of the card conveying route for printing a pattern onto the card after the cam pushes the encoder roller bearer away from the encoder roller.

10. The card printer of claim 9 further comprising:
an idler bearer; and
an idler installed on the idler bearer for pressing against the card when the card is conveyed to the card conveying route.

11. The card printer of claim 10 further comprising:
a gear set with one end connected to the cam; and
an idle cam connected to another end of the gear set for pushing the idler bearer away from the encoder roller when the cam pushes the encoder roller bearer away from the magnetic head.

12. The card printer of claim 9 further comprising a magnetic head bearer on which the magnetic head is installed.

13. The card printer of claim 11 wherein the cam pushes the magnetic head bearer away from the encoder roller when the cam pushes the encoder roller bearer away from the magnetic head.

14. The card printer of claim 9 further comprising a bearing roller installed at both sides of the card conveying route for confining the card to be conveyed along the card conveying route.

15. The card printer of claim 9 further comprising an enabling sensor installed on both sides of the card conveying route for generating an enabling signal to enable the magnetic head when the card passes by the enabling sensor along the card conveying route.

16. The card printer of claim 9 further comprising an automatic card feeder for containing the card and feeding the card into the card conveying route.
